(19) United States
(12) Patent Application Publication
(10) Pub. No.: US 2006/0208705 A1
(43) Pub. Date: Sep. 21, 2006

(54) Method & apparatus to ensure that saturation of the battery does not occur during resonant finding phase as well as implementation methods to quickly find resonance

(76) Inventor: John Fee, Garland, TX (US)

Correspondence Address: JACKSON WALKER LLP, 901 MAIN STREET, SUITE 6000, DALLAS, TX, 75202-3797, US

(21) Appl. No.: 11/363,570

(22) Filed: Feb. 27, 2006

Related U.S. Application Data
(60) Provisional application No. 60/656,284, filed on Feb. 25, 2005.
(60) Provisional application No. 60/657,091, filed on Feb. 25, 2005.
(60) Provisional application No. 60/656,285, filed on Feb. 25, 2005.
(60) Provisional application No. 60/656,283, filed on Feb. 25, 2005.

(51) Int. Cl. H02J 7/00

(52) U.S. Cl. 320/137

(57) ABSTRACT

One embodiment of the present invention provides that saturation will not be not reached by initially probing the battery and taking data on the current as the probe frequency is swept. At or near resonance the current will begin to increase. At this point the signal generator reduces the current to a present level (a limit) and keeps track of the current CHANGE. This process is repeated as the signal is swept and at resonance the CHANGE will be maximum (when compared to the average). In other words, the first signal NOT at resonance is kept as the ceiling and any change is noted against this ceiling. The second derivative of the change can show the minima which when plotted versus frequency will yield the correct resonance.

### CLAIM OF PRIORITY

This application claims priority of U.S. Provisional application Ser. No. 60/656,284 filed Feb. 25, 2005, entitled “Method & Apparatus to Provide Adaptive Variable Frequency Charging Pulses to Nickel and SLA Battery Types”; U.S. Provisional application Ser. No. 60/657,091 filed Feb. 25, 2005, entitled “Method & Apparatus to Ensure That Saturation Of the Battery Does Not Occur During Resonant Finding Phase As Well As Implementation Methods To Quickly Find Resonance”; U.S. Provisional application Ser. No. 60/656,285 filed Feb. 25, 2005 entitled “Method and Apparatus to Provide Charging Waveform To Lithium Ion Batteries”; and U.S. Provisional application Ser. No. 60/656,283, filed Feb. 25, 2005, entitled “Method and Apparatus to Provide Programmable Waveform Generator Battery Charger”.

Problem: During the battery resonant finding phase it is possible to saturate the battery because at resonance the sink current from the source is at its maximum. Since the battery should never be driven to nonlinearity because it might yield a false resonance, a method is needed to ensure that saturation is never achieved.

### BRIEF DESCRIPTION OF THE DRAWINGS

FIG. 1 is a waveform showing the second derivative to yield correct resonance;

FIG. 2 is a waveform of a probing signal;

FIG. 3 is a waveform of a statistical peak; and

FIG. 4 is a circuit for performing a FFT.

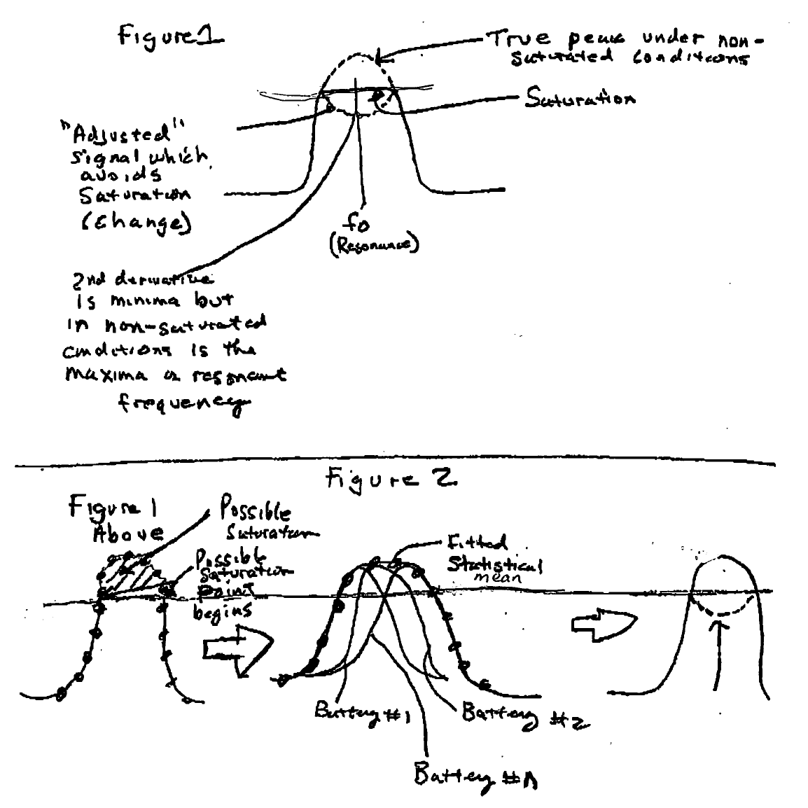

Solution: One embodiment of the present invention provides that saturation will not be not reached by initially probing the battery and taking data on the current as the probe frequency is swept. At or near resonance the current will begin to increase. At this point the signal generator reduces the current to a present level (a limit) and keeps track of the current CHANGE. This process is repeated as the signal is swept and at resonance the CHANGE will be maximum (when compared to the average). In other words, the first signal NOT at resonance is kept as the ceiling and any change is noted against this ceiling. The second derivative of the change can show the minima which when plotted versus frequency will yield the correct resonance. The embodiment of the invention is shown in FIG. 1.

Another embodiment of the invention comprises a method keeping statistical data from a series of like batteries and the peak of the charging current statistical frequency or resonance is then curve fitted. When sweeping or probing the new battery the signal is compared against the fitted graph and when resonance is near, the probing signal is reduced to avoid saturation. This embodiment of the invention is shown in FIG. 2.

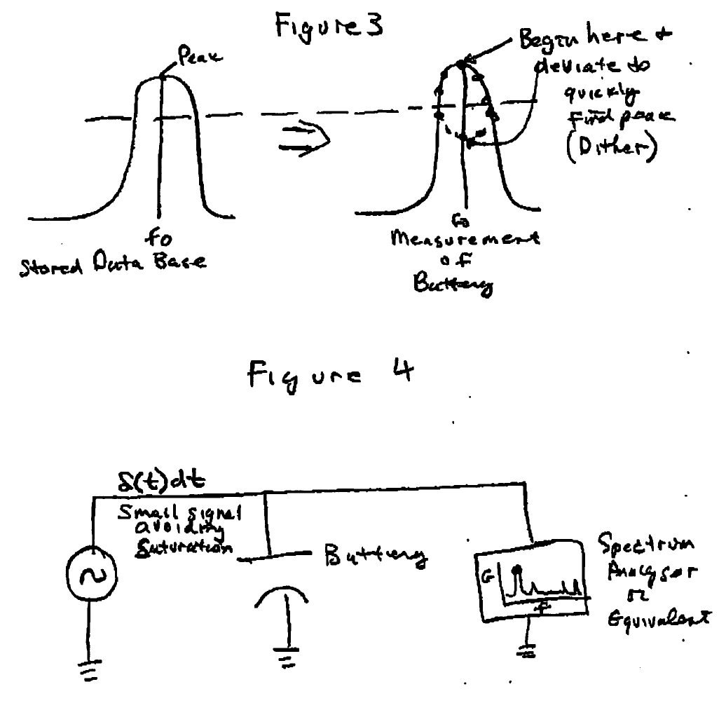

Another embodiment of the invention provides the use of the statistical data and the current change discussed above to speed up the resonance finding operation. The algorithm “guesses” at the peak by looking up the statistical peak (or resonance) and then begins the search around the peak by limiting the current and tracking the peak or CHANGE as per above to yield a precise per battery resonance. This embodiment is shown in FIG. 3.

In addition during the analog sweep (in the analog case it is swept from the start frequency to the stop frequency) or the digital signal processing (in the digital case one method of the invention provides a low power impulse function and performs a FFT on the resultant battery response thereby convolving the real resonance peaks as well as the imaginary components) the result can be stored on a local memory for analysis of the starting point. The result can be stored on a local memory for analysis of the starting point. Proper determination of the resonant frequency accounts for any multiple peaks along the spectrum. This is depicted in FIG. 4.

We claim:

1. A battery charger adapted to charge a battery and control or eliminate battery saturation.
